(19) United States
(12) Patent Application Publication
(10) Pub. No.: US 2025/0308731 A1
(43) Pub. Date: Oct. 2, 2025

(54) CERAMIC COMPONENT AND METHOD FOR MANUFACTURING CERAMIC COMPONENT

(71) Applicant: Panasonic Intellectual Property Management Co., Ltd., Osaka (JP)

(72) Inventors: YASUTAKA OKAMOTO, HOKKAIDO (JP); SATOSHI KAWAMURA, HOKKAIDO (JP); NAOKI MUTOU, HOKKAIDO (JP); DAIKI NAKAYAMA, HOKKAIDO (JP)

(21) Appl. No.: 19/064,789

(22) Filed: Feb. 27, 2025

(30) Foreign Application Priority Data
Mar. 26, 2024 (JP) 2024-050543

(51) Int. Cl. H01C 1/028; H01C 7/112; H01C 17/02

(52) U.S. Cl. CPC H01C 1/028; H01C 7/112; H01C 17/02

(57) ABSTRACT

A ceramic component is excellent in leakage current suppression property, plating flow suppression property, and moisture resistance, and has improved electrode fixing strength. The ceramic component includes a ceramic body, an internal electrode disposed inside the ceramic body, an insulation layer covering a surface of the ceramic body, and an external electrode covering a part of a surface of the insulation layer and electrically connected to the internal electrode. The insulation layer includes a flat portion and a plurality of projections.

### BACKGROUND

### 1. Technical Field

The present disclosure relates to a ceramic component and a method for manufacturing a ceramic component, and more particularly to a ceramic component including an insulation layer and a method for manufacturing a ceramic component including an insulation layer.

### 2. Description of the Related Art

Various ceramic components such as varistors are used for various electronic apparatuses, electronic devices, and the like. Varistors are used for the purposes of protecting various electronic apparatuses, electronic devices, and the like from abnormal voltages caused by lightning surges, static electricity, and the like, and preventing malfunctions of the electronic apparatuses, the electronic devices, and the like due to noise generated in circuits, and other purposes. In a ceramic component, an insulation layer is provided on a surface of a ceramic body for various purposes.

PTL 1 discloses an electrically conductive chip type ceramic element including an electrically conductive chip type ceramic body, a terminal electrode having a baked electrode layer and a plating layer, and an insulation inorganic layer having a melting point or a softening point higher than a firing temperature during formation of the baked electrode layer. It is described that the insulation inorganic layer reacts with and melts in an inorganic binder, is absorbed by the electrode layer, and disappears during the formation of the baked electrode layer, and is formed by PVD or CVD. According to the ceramic element described in PTL 1, solder heat resistance and solder adhesion are excellent, there is no change in resistance value due to plating treatment of an electrode, and reliability can be increased.

### Citation List

### Patent Literature

PTL 1: Unexamined Japanese Patent Publication No. H5-251210

### SUMMARY

However, in the technique using the insulation layer described in PTL 1, in a ceramic component, there is a possibility that a plating flow occurs during formation of a plating electrode on a surface of an external electrode, and the yield is lowered. In addition, there is a problem that electrode fixing strength between the insulation inorganic layer and the external electrode described above is low, and there is a possibility that water enters in a wet environment, resulting in low moisture resistance. In addition, the ceramic component is also required to suppress a leak current through the insulation layer between external electrodes, that is, to have excellent leakage current suppression property.

An object of the present disclosure is to provide a ceramic component having excellent leakage current suppression property, plating flow suppression property, and moisture resistance, and having improved electrode fixing strength, and a method for manufacturing the ceramic component.

A ceramic component according to an aspect of the present disclosure includes a ceramic body, an internal electrode disposed inside the ceramic body, an insulation layer covering a surface of the ceramic body, and an external electrode covering a part of a surface of the insulation layer and electrically connected to the internal electrode. The insulation layer includes a flat portion and a plurality of projections.

A method for manufacturing a ceramic component according to an aspect of the present disclosure includes: a first step of forming a ceramic body having an internal electrode inside; a second step of forming an insulation layer having a flat portion and a plurality of projections on a surface of the ceramic body; and a third step of forming an external electrode on a part of a surface of the insulation layer.

According to the present disclosure, it is possible to provide a ceramic component having excellent leakage current suppression property, plating flow suppression property, and moisture resistance, and having improved electrode fixing strength, and a method for manufacturing the ceramic component.

### BRIEF DESCRIPTION OF THE DRAWINGS

FIG. 1 is a schematic cross-sectional view illustrating a ceramic component according to the present exemplary embodiment; and

FIG. 2 is a diagram illustrating a scanning electron microscope photograph of a cross section of an insulation layer in the ceramic component.

### DETAILED DESCRIPTIONS

### 1. Outline

An outline of ceramic component 1 will be described below with reference to the drawings. Note that the drawings are schematic diagrams, and the ratios of the size and thickness of each component in the drawings does not necessarily reflect the actual dimensional ratios.

In order to solve the above-described problems, the inventors have found that there is a relationship between the shape of a surface of an insulation layer and various characteristics of the ceramic component in conducting intensive studies on each configuration of the ceramic component, and have completed the present disclosure.

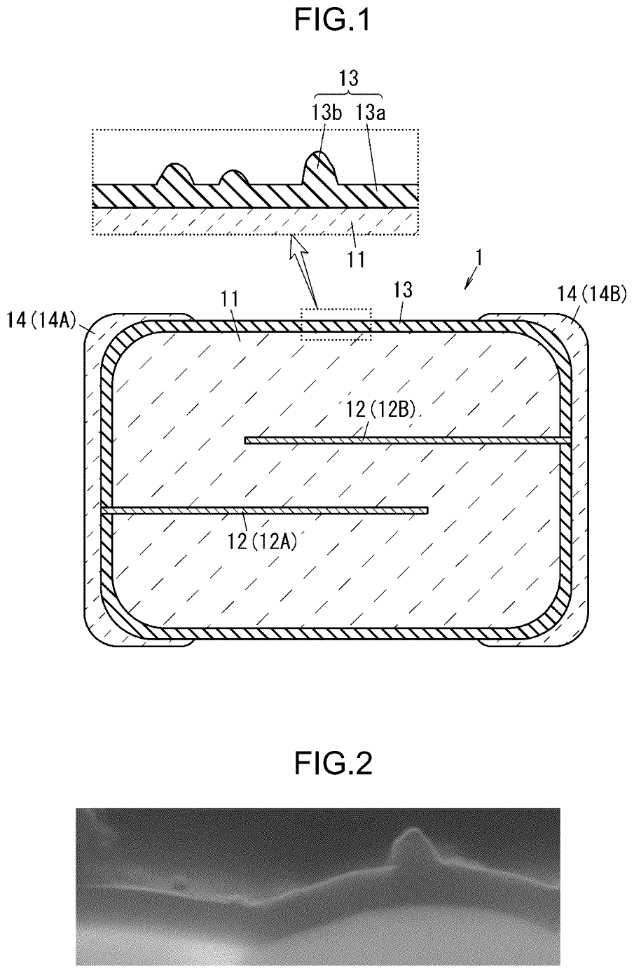

Ceramic component 1 according to the present exemplary embodiment includes ceramic body 11, internal electrode 12, insulation layer 13, and external electrode 14. Internal electrode 12 is disposed inside ceramic body 11. Insulation layer 13 covers a surface of ceramic body 11. External electrode 14 covers a part of a surface of insulation layer 13 and is electrically connected to internal electrode 12. In ceramic component 1 according to the present exemplary embodiment, as illustrated in FIG. 1, insulation layer 13 has flat portion 13a and a plurality of projections 13b.

Ceramic component 1 is excellent in leakage current suppression property, plating flow suppression property, and moisture resistance, and has improved electrode fixing strength. The reason why ceramic component 1 has the above-described configuration and thus exhibits these characteristics can be inferred as follows, for example. It is considered that since insulation layer 13 of ceramic component 1 has projections 13b, the creepage distance of the surface of insulation layer 13 is further increased and thus a leak current is further reduced. In addition, since insulation layer 13 has an uneven shape, ceramic component 1 can further reduce a plating flow. In addition, since insulation layer 13 has an uneven structure, it is considered that entry of water can be further reduced, and as a result, moisture resistance is improved. Furthermore, it is considered that the fixing strength between insulation layer 13 and external electrode 14 further increases due to the anchor effect of the surface of insulation layer 13, and as a result, the insulation properties of portions other than the electrodes are improved.

A method for manufacturing ceramic component 1 according to the present exemplary embodiment includes a first step, a second step, and a third step. In the first step, ceramic body 11 having internal electrode 12 inside is formed. In the second step, insulation layer 13 having flat portion 13a and the plurality of projections 13b is formed on the surface of ceramic body 11. In the third step, external electrode 14 is formed on a part of the surface of insulation layer 13.

According to the method for manufacturing ceramic component 1, by adopting the structure in which insulation layer 13 has flat portion 13a and projections 13b, ceramic component 1 excellent in the above-described leakage current suppression property, plating flow suppression property, moisture resistance, and electrode fixing strength can be easily and reliably manufactured.

### 2. Details

### Ceramic Component

Ceramic component 1 according to the present exemplary embodiment includes ceramic body 11, internal electrode 12, insulation layer 13, and external electrode 14, and may further include a plating electrode. Examples of ceramic component 1 according to the present exemplary embodiment include a varistor, a thermistor, and a ceramic capacitor. A case where ceramic component 1 according to the present exemplary embodiment is varistor 1 will be described as an example.

At least a pair of internal electrodes 12 and a pair of external electrodes 14 may be provided in varistor 1. Varistor 1 illustrated in FIG. 1 includes a pair of internal electrodes 12 and a pair of external electrodes 14. The pair of internal electrodes 12 includes, for example, first internal electrode 12A and second internal electrode 12B. The pair of external electrodes 14 includes, for example, first external electrode 14A provided on one end surface of ceramic body 11 and second external electrode 14B provided on the other end surface of ceramic body 11. First internal electrode 12A is electrically connected to first external electrode 14A, and second internal electrode 12B is electrically connected to second external electrode 14B. In varistor 1, one of first external electrode 14A and second external electrode 14B serves as an electrode on the high potential side, and the other of first external electrode 14A and second external electrode 14B serves as an electrode on the low potential side.

### Ceramic Body

In varistor 1, ceramic body 11 includes, for example, a semiconductor ceramic component having non-linear resistance characteristics. Ceramic body 11 usually contains ZnO as a main component, and may contain Bi₂O₃, Co₂O₃, MnO₂, Sb₂O₃, Pr₆O₁₁, CaCO₃, Cr₂O₃, or the like as an accessory component. Ceramic body 11 is formed by solid solution sintering of the main component such as ZnO with a part of the accessory component in a semiconductor ceramic component, and precipitation of the remaining accessory component at grain boundaries between the main and accessory components.

### Internal Electrode

Internal electrode 12 is disposed inside ceramic body 11. Internal electrode 12 contains, for example, a metal such as Ag, Pd, PdAg, or PtAg. Ceramic body 11 having internal electrode 12 inside is formed, for example, by laminating and firing ceramic sheets coated with an internal electrode paste containing any one or more of these metals.

### Insulation Layer

Insulation layer 13 covers at least a part of ceramic body 11. Insulation layer 13 preferably covers the entire surface of ceramic body 11.

FIG. 2 illustrates a scanning electron microscope (SEM) photograph of a cross section of insulation layer 13. Insulation layer 13 includes flat portion 13a and the plurality of projections 13b. As illustrated in FIGS. 1 and 2, flat portion 13a is a film-shaped portion included in insulation layer 13 and having a substantially constant thickness and overlapping the surface of ceramic body 11. “Having the substantially constant thickness” means that the maximum thickness is less than or equal to 1.2 times the minimum thickness in flat portion 13a. Specifically, flat portion 13a is, for example, formed along the surface shape of crystal grains or the like of a surface layer of ceramic body 11, and may have a planar shape or a curved surface shape. Projections 13b are portions included in insulation layer 13 and present on a surface of flat portion 13a on the opposite side of ceramic body 11, and are particles present on the surface of flat portion 13a or are portions protruding in a particle shape from the surface of flat portion 13a.

### Flat Portion

The average thickness of flat portion 13a is preferably greater than or equal to 0.05 μm and less than or equal to 1 μm. By setting the average thickness of flat portion 13a within the above-described range, the leakage current suppression property, the plating flow suppression property, the moisture resistance, and the electrode fixing strength can be further improved. The average thickness of flat portion 13a is more preferably greater than or equal to 0.1 μm, still more preferably greater than or equal to 0.15 μm. The average thickness of flat portion 13a is more preferably less than or equal to 0.5 μm, and still more preferably less than or equal to 0.3 μm. The “average thickness” of flat portion 13a means an arithmetic average value of thicknesses measured at a plurality of points (for example, arbitrary 10 points) of a cross section of flat portion 13a.

### Projections

The number of projections 13b is plural, that is, greater than or equal to 2, preferably greater than or equal to 10, more preferably greater than or equal to 100, and still more preferably greater than or equal to 1000. The existence density of projections 13b is preferably greater than or equal to 250/μm², and more preferably greater than or equal to 500/μm². The existence density of projections 13b is, for example, less than or equal to 1000/μm². The plurality of projections 13b are usually randomly dispersed on the surface of flat portion 13a.

The size of each of projections 13b is preferably greater than or equal to 0.1 μm and less than or equal to 10 μm. By setting the size of each of projections 13b within the above-described range, the leakage current suppression property, the plating flow suppression property, the moisture resistance, and the electrode fixing strength can be further improved. The size of each of projections 13b is more preferably greater than or equal to 0.5 μm, still more preferably greater than or equal to 1 μm. The size of each of projections 13b is more preferably less than or equal to 8 μm, and still more preferably less than or equal to 5 μm. The “size” of each of projections 13b means the average major diameter of the projections. The “major diameter” of each of the projections refers to the longest diameter in the three-dimensional shape of the projection 13b, and the “average major diameter” refers to the arithmetic average value of the major diameters measured for a plurality of (for example, arbitrary 10 points) projections 13b. The average major diameter of the projections can be measured by, for example, observing the insulation layer with an electron microscope.

Examples of a substance constituting flat portion 13a or projections 13b include SiO₂, ZrO₂, Al₂O₃, and ZnO. Among them, at least one of SiO₂ and ZrO₂ is preferable. In addition, it is preferable that flat portion 13a and projections 13b contain SiO₂. In this case, the leakage current suppression property, the plating flow suppression property, the moisture resistance, and the electrode fixing strength can be further improved.

A composition of flat portion 13a may be identical to a composition of projections 13b. In this case, the leakage current suppression property, the plating flow suppression property, the moisture resistance, and the electrode fixing strength can be further improved. The composition of flat portion 13a or the composition of projections 13b means the types of an inorganic substance and the like constituting flat portion 13a or projections 13b and the content ratio (% by mass) of each substance. The fact that “the compositions are identical” in flat portion 13a and projections 13b means that 95% by mass or more of a substance constituting flat portion 13a and 95% by mass or more of a substance constituting projections 13b are the same.

Flat portion 13a and projections 13b having the identical compositions are formed using, for example, atomic layer deposition (ALD). Flat portion 13a can be formed by depositing an atomic layer by ALD, and projections 13b can be formed by allowing particles formed by ALD to be present on the surface of flat portion 13a. In addition, projections 13b may be formed by allowing particles such as insulation particles having a composition identical to that of separately prepared flat portion 13a to be present on the surface of flat portion 13a during or after the formation of flat portion 13a by ALD.

The composition of flat portion 13a may be different from the composition of projections 13b. In this case, the characteristics of the leakage current suppression property, the plating flow suppression property, the moisture resistance, and the electrode fixing strength can be adjusted, and these characteristics can be further improved by a combination of the compositions. The fact that the “compositions are different” between flat portion 13a and projections 13b means that the compositions are not the same, that is, 5% by mass or more of the substance constituting flat portion 13a is different from 5% by mass or more of the substance constituting projections 13b.

Flat portion 13a and projections 13b having different compositions can be formed, for example, by using ALD to form flat portion 13a and causing particles such as insulation particles having a composition different from that of flat portion 13a to be present on the surface of flat portion 13a during or after the formation of flat portion 13a.

### External Electrode

External electrode 14 covers at least a part of insulation layer 13 and is electrically connected to internal electrode 12. In ceramic component 1 according to the present exemplary embodiment, since insulation layer 13 has projections 13b, external electrode 14 can exhibit an anchor effect, thereby improving the electrode fixing strength. In a conventional ceramic component, peeling of an external electrode is likely to occur due to, for example, excessively high smoothness of an insulation layer formed by PVD, CVD, ALD, or the like.

External electrode 14 contains, for example, a metal component such as Ag, AgPd, or AgPt, and a glass component such as Bi₂O₃, SiO₂, or B₂O₃. External electrode 14 preferably contains a metal as a main component, and more preferably contains Ag as a main component.

External electrode 14 may have a single-layer structure (external electrode 14A and external electrode 14B) or a multilayer structure having a plurality of layers.

External electrode 14 is usually formed by applying an external electrode paste onto a part of the surface of insulation layer 13.

### Plating Electrode

The plating electrode covers at least a part of external electrode 14. In ceramic component 1 according to the present exemplary embodiment, insulation layer 13 has projections 13b, and thus the plating flow suppression property is excellent. In the conventional ceramic component, a plating flow is likely to occur due to excessively high smoothness of the insulation layer formed by PVD, CVD, ALD, or the like. The plating electrode includes, for example, a Ni electrode covering at least a part of external electrode 14, and a Sn electrode covering at least a part of the Ni electrode.

### Method for Manufacturing Ceramic Component

The method for manufacturing the ceramic component according to the present exemplary embodiment includes a first step, a second step, and a third step. The method for manufacturing the ceramic component may further include a step of forming the plating electrode as a fourth step.

### First Step

In the first step, ceramic body 11 having internal electrode 12 inside is formed.

In the first step, for example, an internal electrode paste is applied to ceramic sheets prepared using a slurry containing ZnO, and the ceramic sheets are laminated, pressed, and cut, and then debound and fired to prepare ceramic body 11 having internal electrode 12 inside. The slurry can be prepared, for example, by mixing ZnO as a main raw material, Bi₂O₃, Co₂O₃, MnO₂, Sb₂O₃, Pr₆O₁₁, CaCO₃, Cr₂O₃, or the like as a sub-raw material, and a binder.

For example, an Ag paste, a Pd paste, a Pt paste, a PdAg paste, a PtAg paste, or the like can be used as the internal electrode paste.

The temperature at which the debinding is performed is, for example, higher than or equal to 300° C. and lower than or equal to 500° C. The temperature at which the firing is performed can be appropriately adjusted based on the configuration, composition, and the like of ceramic body 11 to be obtained, and is, for example, higher than or equal to 800° C. and lower than or equal to 1300° C.

### Second Step

In the second step, insulation layer 13 having flat portion 13a and the plurality of projections 13b is formed on the surface of ceramic body 11.

Examples of a method for forming insulation layer 13 having flat portion 13a and projections 13b include (i) a method using atomic layer deposition, (ii) a method in which projections 13b are formed by attaching a plurality of insulation particles to flat portion 13a being formed, and (iii) a method in which a precursor slurry containing insulation particles is applied.

In the method of (i), flat portion 13a and projections 13b are formed on the surface of ceramic body 11 by atomic layer deposition (ALD). Specifically, for example, ceramic body 11 is placed in a container such as a basket in a vacuum chamber of an ALD device, and while the container is rotated, a gaseous precursor and humidified Ar, O₂, and the like as oxidant gas are alternately introduced and exhausted to form insulation layer 13. In this case, a powdery atomic layer deposit attached to the container such as the basket is detached from flat portion 13a being formed of the atomic layer deposit by ALD, and projections 13b are formed so as to be attached to the surface of flat portion 13a. In the method of (i), the composition of flat portion 13a formed is usually identical to the composition of projections 13b formed. Furthermore, according to the method of (i), the sizes and existence density of projections 13b can be changed by adjusting the time to perform ALD, the rotation speed of the container, and the like.

As the precursor in ALD, for example, SiH[N(CH₃)₂]₃ or the like is used for forming SiO₂, Al(CH₃)₃ or the like is used for forming Al₂O₃, Zr[N(CH₃)(C₂H₅)]₄ or the like is used for forming ZrO₂, and Zn(CH₃)₂ or the like is used for forming ZnO. In addition, a humidified Ar gas or the like is used as the oxidant gas for the formation of these substances.

In the method of (ii), projections 13b are formed by attaching the plurality of insulation particles to flat portion 13a being formed. Specifically, for example, while flat portion 13a is being formed by ALD or a method other than ALD, the insulation particles are added to the surface of flat portion 13a to form projections 13b. Examples of a substance constituting the insulation particles include SiO₂, ZrO₂, Al₂O₃, and ZnO. A composition of the insulation particles may be identical to or different from the composition of the flat portion 13a. According to the method of (ii), the sizes and existence density of projections 13b can be changed by adjusting the size and amount of the insulation particles to be added.

In the method of (iii), the precursor slurry containing a precursor substance of insulation layer 13 and the insulation particles is applied to the surface of ceramic body 11, and then subjected to heat treatment, and dehydrated and cured to form flat portion 13a and projections 13b. Examples of the precursor substance contained in the precursor slurry include a glass component having Si in a main chain such as polysilazane. Thus, flat portion 13a made of SiO₂ can be formed. Examples of a substance constituting the insulation particles include SiO₂, ZrO₂, Al₂O₃, and ZnO. A composition of the insulation particles may be identical to or different from the composition of flat portion 13a. Examples of a method for applying the precursor slurry include spraying (spraying), immersion, and printing.

In the second step, the density of insulation layer 13 is further increased by forming a part or all of insulation layer 13 by atomic layer deposition, whereby the water intrusion suppression property of ceramic component 1 is further improved, and the moisture resistance can be further improved.

### Third Step

In the third step, external electrode 14 is formed on a part of the surface of insulation layer 13.

In the third step, for example, an external electrode paste is applied to a part of the surface of insulation layer 13 so as to be in contact with a part of internal electrode 12, and then baked to form external electrode 14. The external electrode paste can be prepared by mixing, for example, a metal component containing Ag powder, AgPd powder, AgPt powder, or the like, a glass component containing Bi₂O₃, SiO₂, B₂O₃, or the like, and a solvent. In addition, a paste containing Ag as a main component and containing a resin component or the like can also be used as the external electrode paste. Examples of a method for applying the external electrode paste include immersion and printing. The temperature at which the baking is performed is, for example, higher than or equal to 700° C. and lower than or equal to 800° C.

### Fourth Step

In the fourth step, the plating electrode is formed so as to cover at least a part of external electrode 14. As a method for forming the plating electrode, for example, Ni plating and Sn plating are sequentially performed by an electrolytic plating method.

### Performance of Ceramic Component

Ceramic component 1 according to the present exemplary embodiment and a conventional ceramic component were evaluated and compared in terms of the leakage current suppression property.
Ceramic component 1 according to the present exemplary embodiment: A varistor in which an insulation layer made of SiO₂ and having a flat portion and projections is formed by atomic layer deposition.
The conventional ceramic component: A varistor in which a precursor solution containing polysilazane is applied to a surface of a ceramic body, and then heat-treated to form an insulation layer made of SiO₂ and having a flat portion and having no projection.

Each of the prepared ceramic components was subjected to a pressure cooker bias test (PCBT) for 48 hours, and then a change rate (%) of ΔV_{1 μA} was measured 20 times (n=20) for each of the prepared ceramic components.

ΔV_{1 μA} (%)=(V_{1 μA} after the test−V_{1 μA} before the test)×100/V_{1 μA} before the test

The arithmetic average value and the minimum value of the measured values when the number n of measurements is 20, and a ratio of the number of measured change rates less than or equal to −3% to 20 which is the number of measurements are shown in the following Table 1 for each of the ceramic components.

The ratio of the number of measured change rates ΔV_{1 μA} less than or equal to −3% to 20 which is the number of measurements indicates easiness of occurrence of a leak current, and the lower the ratio is, the better the leakage current suppression property is.

TABLE 1

| | Change rate (%) of ΔV_{1μA} (n = 20) | | |
|---|---|---|---|
| | | | Ratio of the number of |
| | Average | Minimum | measured change rates |
| | value | value | less than or equal to −3% |
| Conventional | −0.34 | −3.34 | 2/20 |
| ceramic component | | | |
| Ceramic | −0.33 | −0.61 | 0/20 |
| component 1 | | | |
| according to the | | | |
| present embodiment | | | |

As is apparent from the results in Table 1, ceramic component 1 according to the present exemplary embodiment is superior in leakage current suppression property to the conventional ceramic component having no projection.

It is considered that ceramic component 1 according to the present exemplary embodiment, such as a thermistor or a ceramic capacitor other than varistor 1, is also excellent in leakage current suppression property, plating flow suppression property, and moisture resistance, and has improved electrode fixing strength.

### Conclusions

As apparent from the above-described exemplary embodiments, the present disclosure includes the following aspects. In the following, reference signs are given in parentheses only to clarify the correspondence relationship with the exemplary embodiments.

A ceramic component (1) according to a first aspect includes a ceramic body (11), an internal electrode (12) disposed inside the ceramic body (11), an insulation layer (13) covering a surface of the ceramic body (11), and an external electrode (14) covering a part of a surface of the insulation layer (13) and electrically connected to the internal electrode (12). The insulation layer (13) has a flat portion (13a) and a plurality of projections (13b).

According to the first aspect, the ceramic component (1) is excellent in leakage current suppression property, plating flow suppression property, and moisture resistance, and has improved electrode fixing strength.

In the ceramic component (1) according to a second aspect, in the first aspect, an average thickness of the flat portion (13a) is greater than or equal to 0.05 μm and less than or equal to 1 μm.

According to the second aspect, in the ceramic component (1), the leakage current suppression property, the plating flow suppression property, the moisture resistance, and the electrode fixing strength can be further improved by setting the average thickness of the flat portion (13a) within the above-described range.

In the ceramic component (1) according to a third aspect, in the first or second aspect, sizes of the projections (13b) are greater than or equal to 0.1 μm and less than or equal to 10 μm.

According to the third aspect, in the ceramic component (1), the leakage current suppression property, the plating flow suppression property, the moisture resistance, and the electrode fixing strength can be further improved by setting the sizes of the projections (13b) within the above-described range.

In the ceramic component (1) according to a fourth aspect, in any one of the first to third aspects, a composition of the flat portion (13a) is identical to a composition of the projections (13b).

According to the fourth aspect, by making the composition of the flat portion (13a) identical to the composition of the projections (13b), the leakage current suppression property, the plating flow suppression property, the moisture resistance, and the electrode fixing strength can be further improved.

In the ceramic component (1) according to a fifth aspect, in any one of the first to third aspects, the composition of the flat portion (13a) is different from the composition of the projections (13b).

According to the fifth aspect, the leakage current suppression property, the plating flow suppression property, the moisture resistance, and the electrode fixing strength can be adjusted, and these characteristics can be further improved by a combination of the compositions.

In the ceramic component (1) according to a sixth aspect, in the first to fifth aspects, the ceramic body (11) contains ZnO as a main component, and the flat portion (13a) and the projections (13b) of the insulation layer (13) contain SiO₂.

According to the sixth aspect, it is possible to obtain a varistor in which leakage current suppression property, plating flow suppression property, moisture resistance, and electrode fixing strength are further improved.

A method for manufacturing a ceramic component (1) according to a seventh aspect includes a first step, a second step, and a third step. In the first step, the ceramic body (11) having an internal electrode (12) inside is formed. In the second step, an insulation layer (13) having a flat portion (13a) and a plurality of projections (13b) is formed on a surface of the ceramic body (11). In the third step, an external electrode (14) is formed on a part of a surface of the insulation layer (13).

According to the seventh aspect, it is possible to easily and reliably manufacture the ceramic component (1) having excellent leakage current suppression property, plating flow suppression property, and moisture resistance and improved electrode fixing strength.

In the method for manufacturing the ceramic component (1) according to an eighth aspect, in the seventh aspect, in the second step, the insulation layer (13) is formed by atomic layer deposition.

According to the eighth aspect, the insulation layer (13) is formed by atomic layer deposition to have a higher density, and thus the ceramic component (1) can have further improved water entry suppression property and further improved moisture resistance.

In the method for manufacturing the ceramic component (1) according to a ninth aspect, in the seventh or eighth aspect, in the second step, the projections (13b) are formed by attaching a plurality of insulation particles to the flat portion (13a) being formed.

According to the ninth aspect, it is possible to more easily and reliably form the insulation layer (13) in which a composition of the flat portion (13a) is identical to or different from a composition of the projections (13b).

What is claimed is:

1. A ceramic component comprising:
a ceramic body;
an internal electrode disposed inside the ceramic body;
an insulation layer covering a surface of the ceramic body; and
an external electrode covering a part of a surface of the insulation layer and electrically connected to the internal electrode,
wherein the insulation layer includes a flat portion and a plurality of projections.

2. The ceramic component according to claim 1, wherein an average thickness of the flat portion is greater than or equal to 0.05 μm and less than or equal to 1 μm.

3. The ceramic component according to claim 1, wherein a size of each of the projections is greater than or equal to 0.1 μm and less than or equal to 10 μm.

4. The ceramic component according to claim 1, wherein a composition of the flat portion is identical to a composition of each of the projections.

5. The ceramic component according to claim 1, wherein a composition of the flat portion is different from a composition of each of the projections.

6. The ceramic component according to claim 1, wherein
the ceramic body contains ZnO as a main component, and
the flat portion and the projections of the insulation layer each contain SiO₂.

7. A method for manufacturing a ceramic component, the method comprising:
a first step of forming a ceramic body having an internal electrode inside;
a second step of forming an insulation layer having a flat portion and a plurality of projections on a surface of the ceramic body; and
a third step of forming an external electrode on a part of a surface of the insulation layer.

8. The method according to claim 7, wherein in the second step, the insulation layer is formed by atomic layer deposition.

9. The method according to claim 7, wherein in the second step, the projections are formed by attaching a plurality of insulation particles to the flat portion being formed.
